(19) United States
(12) Patent Application Publication
(10) Pub. No.: US 2006/0285128 A1
(43) Pub. Date: Dec. 21, 2006

(54) Apparatus and method of selecting a plurality of print settings in a print setup operation

(75) Inventor: Mi-kyung Choi, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/453,011

(22) Filed: Jun. 15, 2006

(30) Foreign Application Priority Data
Jun. 16, 2005 (KR) 2005-52035

(51) Int. Cl. G06F 3/12

(52) U.S. Cl. 358/1.1; 358/1.15

(57) ABSTRACT

An apparatus and method of selecting a plurality of print settings, the apparatus including a user interface unit to display a plurality of first print settings to allow a user to select a plurality of second print settings from the displayed first print settings, a storage unit to store the first and second print settings, and a controller to control the storage of the first and second print settings in the storage unit, and the performance of a print job according to the plurality of second print settings selected by the user interface.

### CROSS-REFERENCE TO RELATED APPLICATIONS

This application claims priority under 35 U.S.C. §119(a) from Korean Patent Application No. 10-2005-0052035, filed on Jun. 16, 2005 in the Korean Intellectual Property Office, the disclosure of which is incorporated herein in its entirety by reference.

### BACKGROUND OF THE INVENTION

1. Field of the Invention

The present general inventive concept relates to an apparatus and method of selecting a plurality of print settings using a setup operation, and more particularly, to an apparatus and method of displaying a plurality of stored print settings and selecting desired ones of the displayed plurality of stored print settings in a print setup operation to be used to print a document.

2. Description of the Related Art

FIG. 1 is a flowchart illustrating a conventional method of printing a document several times using different print settings for each of the times. Referring to FIG. 1, a first print setting, including one or more desired print options, is set in order to print a document using the one or more desired print options (operation 100). The document is printed according to the first print setting (operation 110). After printing a desired number of copies of document according to the first print setting, it is determined whether the document is to be printed again according to a second print setting (operation 120). If it is determined that the document is not to be printed again according to the second print setting, the printing method ends. If it is determined that the document is to be printed again according to the second print setting, operations 100 and 110 are repeated.

Thus, whenever one or more print options of an initial print setting are to be changed to create a subsequent print setting, for example to add or remove print options to or from the initial print setting, the subsequent print setting must be set in a further print setup operation after printing using the initial print setting. Moreover, even if a desired print setting is stored (for example, from a previous printing job), a print option setup window is opened and the desired stored print setting must be selected in a further setup operation after the printing using the initial print setting.

For example, when two copies of a document are to be printed using a first print setting including a “watermark” print option and three copies of a document are to be printed using a second setting including a “no watermark” print option, the first print setting including the “watermark” print option is selected from a print setup at operation 100, and the number of copies of the document to be printed using the first print setting is set to 2. The document is printed two times using the first print setting at operation 110. After the printing using the first print setting, a print setup window is opened at operation 120. An option to print the document again using the second print setting including the no watermark print option is selected at operation 100, and the number of copies of the document to be printed using the second print setting is set to 3. The document is printed three times using the second print setting at operation 110. Thus, when a user wishes to print a document several times using different print settings (including different print options or groups of print options) each time, it is necessary for the user to set the different print settings in individual print setup operations before printing using the different print settings.

As described above, when a document is to be printed using several different print settings, the different print settings are set during several different print setup operations, causing an inconvenience to users. Furthermore, even when a desired print setting to be used to print a document is previously stored (e.g., using a favorite function), the stored print setting must be selected in a separate print setup operation before the document is printed using the selected print setting, causing an inconvenience to users.

### SUMMARY OF THE INVENTION

The present general inventive concept provides an apparatus and method of displaying a plurality of stored print settings (including different print options or groups of print options), setting a plurality of print settings using the displayed print settings at one time (i.e., in a single operation), and selecting the plurality of desired print settings in a print setup operation to print a document according to each of the selected print settings.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to select a plurality of print settings, the apparatus including a user interface unit to display a plurality of first print settings to allow a user to select a plurality of second print settings from the displayed first print settings, a storage unit to store the first and second print settings; and a controller to control the storage of the first and second print settings in the storage unit, and the performance of a print job according to the plurality of second print settings.

The first print settings may be input by the user via the user interface unit or may be previously stored in the storage unit.

The user interface unit may include a first user interface to allow the user to store the plurality of first print settings in the storage unit, and a second user interface to display the plurality of first print settings stored in the storage unit and to allow the user to select one or more of the displayed first print settings as the plurality of second print settings.

The second user interface may include a display box to display the plurality of first print settings stored in the storage unit, at least one input button to select the second print settings from the first print settings displayed on the display box, to remove one or more of the second print settings, or to add one or more new print settings to the second print settings, and a displayer to display the selected plurality of second print settings.

The user interface unit and the controller may be operated by a printer driver or a host application.

The apparatus may further include a driver core to perform a plurality of print jobs under the control of the controller, and the controller may create the plurality of print jobs according to the plurality of second print settings selected by the user and control the driver core to perform the plurality of print jobs.

The apparatus may further include the driver core to perform one print job under the control of the controller, and the controller may create the one print job according to the plurality of second print settings selected by the user, transfers the plurality of second print settings to the driver core, and controls the driver core to repeatedly perform the one print job using the transferred plurality of second print settings.

The foregoing and/or other aspects and utilities of the present general inventive concept may also be achieved by providing a method of selecting a plurality of print settings, the method including displaying a plurality of first print settings and selecting a plurality of second print settings from the plurality of first print settings in a print setup operation.

The first print settings may be input via a user interface unit or may be previously stored.

The method may further include selecting one or more of the plurality of first print settings as the second print settings, and storing the second print settings.

The method may further include creating a print job according to the plurality of second print settings.

The displaying of the plurality of first print settings may include displaying the plurality of first print settings using a display box.

The selecting of the plurality of second print settings may include selecting at least one print setting from the first print settings displayed in the display box, or modifying at least one print setting from the first print settings displayed in the display box and selecting the at least one modified first print setting.

The modifying of the at least one first print setting may include adding or removing one or more print options from the at least one first print setting using at least one input button.

The method may further include displaying the selected plurality of second print settings.

The method may further include performing the created print job.

The creating of the print job according to the plurality of second print settings may include creating a plurality of print jobs according to the plurality of second print settings, and performing the created plurality of print jobs using a driver core.

The creating of the print job according to the plurality of second print settings may include creating one print job according to the plurality of second print settings, transferring the plurality of second print settings to the driver core, and controlling the driver core to repeatedly perform the one print job using the transferred plurality of second print settings.

The foregoing and/or other aspects and utilities of the present general inventive concept may also be achieved by an apparatus to select a plurality of print settings, including an interface to display a plurality of first print settings, a button to select one or more of the first print settings as a plurality of second print settings, and the plurality of second print settings, and a controller to print a document according to the plurality of second print settings.

The interface may display another button to delete at least one of the first print settings and the second print settings. The interface may display another button to modify one or more print options of at least one of the plurality of second print settings.

The foregoing and/or other aspects and utilities of the present general inventive concept may also be achieved by providing a method of selecting a plurality of print settings, including displaying a plurality of first print settings, a button to select one or more of the first print settings as a plurality of second print settings, and the plurality of second print settings, and printing a document according to the plurality of second print settings.

The method may further include displaying another button to delete at least one of the first print settings and the second print settings. The method may further include displaying another button to modify one or more print options of at least one of the plurality of second print settings.

The foregoing and/or other aspects and utilities of the present general inventive concept may also be achieved by providing a method of printing using a plurality of desired print settings, including selecting one or more of a plurality of print settings as one or more second print settings in a print setup operation, and printing using each of the second print settings separately.

The foregoing and/or other aspects and utilities of the present general inventive concept may also be achieved by providing an apparatus to print using a plurality of desired print settings, including a selection unit to select one or more of a plurality of stored print settings as one or more second print settings in a print setup operation, and a control unit to control a printing operation using each of the plurality of second print settings separately.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a conventional method of printing a document several times using different print settings for each of the times;

FIG. 2 is a block diagram illustrating an apparatus to select a plurality of desired print settings according to an embodiment of the present general inventive concept;

FIG. 3 is a view illustrating a display screen of a second user interface of the apparatus illustrated in FIG. 2 according to an embodiment of the present general inventive concept; and

FIG. 4 is a flowchart illustrating a method of selecting a plurality of desired print settings according to an embodiment of the present general inventive concept.

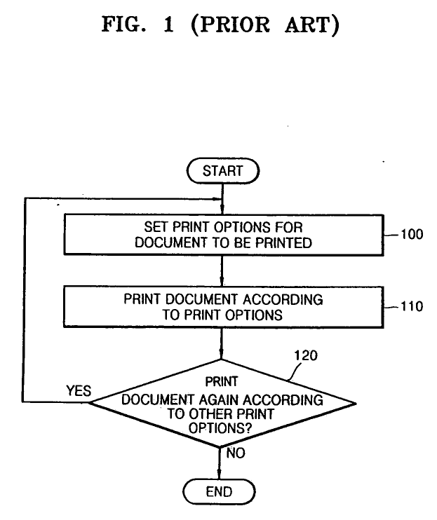

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

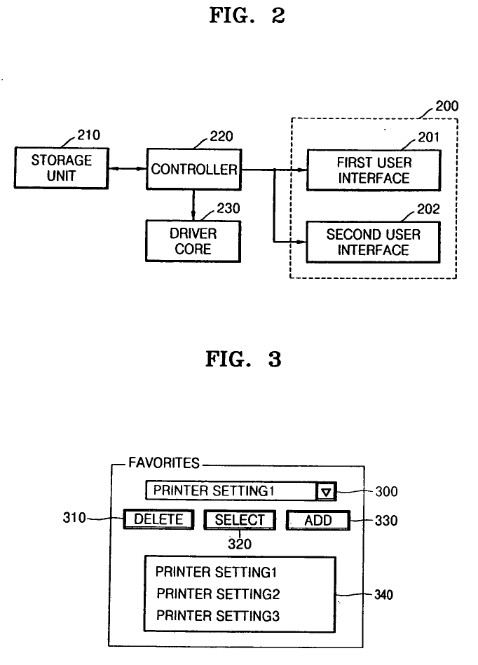

FIG. 2 is a block diagram illustrating an apparatus to select a plurality of desired print settings, according to an embodiment of the present general inventive concept. Referring to FIG. 2, the apparatus includes a user interface 200, a storage unit 210, a controller 220, and a driver core 230.

A print setting includes one or more print options used to print a document a predetermined number of times. Different print settings include one or more different print options from each other. For example, a first print setting may include a “watermark” print option, whereas a second print setting may include a “no watermark” print option. In the present embodiment, a user may select a plurality of print settings in a single print setup operation. The user may then print a document using a first desired print setting from the plurality of print settings, and then may again print the document using the remaining desired print settings without having to select each desired print setting in separate print setup operations (e.g., a different print setup operation used to select a previous desired print setting as compared to a subsequent desired print setting).

The user interface 200 sets one or more print settings during a prior printing operation. The user interface 200 also stores the one or more prior print settings, displays stored print settings, and allows the selection of a plurality of desired print settings from the displayed prior print settings to be used in a current printing operation. Furthermore, as discussed below with reference to FIG. 3, the user interface 200 allows a user to modify displayed print settings, such as by adding or removing one or more print options from a print setting of the displayed print settings, and allows a user to create a new print setting.

The user interface 200 can include, but is not required to include, a first user interface 201 and a second user interface 202. The first user interface 201 may store the one or more prior print settings. The second user interface 202 may display the stored print settings and may allow the selection of one or more prior print settings are the plurality of desired print settings. Furthermore, the second user interface 202 may allow the user to modify displayed print settings, such as by adding or removing one or more print options from the displayed print settings, and may allow the user to create a new print setting as the desired print setting.

FIG. 3 is a view illustrating a display screen of the second user interface 202 of the apparatus illustrated in FIG. 2, according to an embodiment of the present general inventive concept. Referring to FIG. 3, the second user interface 202 displays a display box 300, a removal button 310, a selection button 320, an addition button 330, and a displayer (display unit) 340.

The display box 300 displays a list of stored print settings stored in the storage unit 210.

The selection button 320 allows a user to select one or more of the list of print settings displayed by the display box 300 in a single print setup operation to be used in a print job. The removal button 310 allows the user to remove one or more of the selected print settings (such as one or more erroneously selected print settings). Furthermore, the removal button 310 may also allow the user to remove one or more print options from a print setting of the list of print settings.

The addition button 330 allows the user to add a new desired print setting to the second print settings of the print job. The displayer 340 displays the user-selected print settings of the print job. Thus, while the user-selected print settings are displayed by the displayer 340, the user can remove one or more of the selected print settings (such as one or more erroneously selected print settings) using the removal button 310.

The storage unit 210 stores print settings, including prior print settings and the user-selected print settings. The storage unit 210 can be, but is not limited to, a memory, a flash memory, or a hard disc in a host (not illustrated).

The controller 220 controls a storage of the print settings, including the user-selected print settings, in the storage unit 210. Furthermore, if the user selects a plurality of print settings in a single print setup operation using the user interface 200, the controller 220 creates a print job according to the user-selected plurality of print settings. As discussed above, the plurality of user-selected print settings may include one or more modified versions of previously-stored print settings (such as modified to add or remove one or more print options) and/or one or more newly-created print settings (including one or more print options).

The driver core 230 performs the print job under the control of the controller 220. If the controller 220 creates a plurality of print jobs according to the plurality of user-selected print settings, the driver core 230 performs the plurality of print jobs according to a control signal of the controller 220.

In embodiments of the present general inventive concept, the controller 220 creates one print job according to the user-selected plurality of print settings and transfers the user-selected plurality of print settings to the driver core 230. The driver core 230 then performs one print job by using the received user-selected plurality of print settings under the control of the control signal of the controller 220.

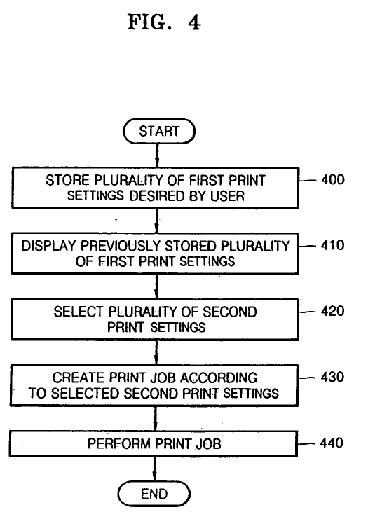

FIG. 4 is a flowchart illustrating a method of selecting a plurality of print settings in a single print setup operation, according to an embodiment of the present general inventive concept. The method of selecting the plurality of print settings will now be described with reference to FIGS. 2, 3, and 4.

Referring to FIGS. 2, 3, and 4, a user may previously store a plurality of desired first print settings during a prior printing operation (operation 400). For example, the user may set a plurality of desired first print settings in the prior printing operation using the first user interface 201, and the controller 220 then stores the first print settings previously set by the user in the prior printing operation in the storage unit 210.

When a user wishes to print a document several times using different print settings each time, the user displays the plurality of first print settings stored in the storage unit 210 using the second user interface 202 (operation 410). The user selects a plurality of desired second print settings in a single print setup operation, which may include selecting one or more of the stored plurality of first print settings displayed by the display box 300 using the selection button 320 of the second user interface 202, and which may include selecting one or more newly-created print settings. (operation 420). If the user erroneously selects a print setting, the user can remove the erroneously selected print setting using the removal button 310. The user can confirm the selected second print settings using the displayer 340.

If the controller 220 receives the plurality of desired second print settings through the second user interface 202, the controller 220 creates a print job according to the second print settings (operation 430).

If the controller 220 creates the print job, the driver core 230 performs the print job under the control of the controller 220 (operation 440). According to embodiments of the present general inventive concept, the driver core 230 can perform a plurality of print jobs according to a plurality of print jobs created by the controller 220. Alternatively, if the controller 220 creates one print job and transfers the plurality of second print settings to the driver core 230, the driver core 230 can repeatedly perform one print job according to a control signal of the controller 220.

The present general inventive concept can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

According to the present general inventive concept, a user sets a plurality of desired print settings in a single print setup operation to be used to print from a displayed list of print settings, thereby solving problems of printing a document according to a print settings and then setting other print settings in a separate print setup operation when the user prints the document according to a plurality of print settings.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to select a plurality of print settings, the apparatus comprising:
a user interface unit to display a plurality of first print settings to allow a user to select a plurality of second print settings from the displayed first print settings;
a storage unit to store the first and second print settings; and
a controller to control the storage of the first and second print settings in the storage unit, and the performance of a print job according to the plurality of second print settings.

2. The apparatus of claim 1, wherein the first print settings are input by the user via the user interface unit or are previously stored in the storage unit.

3. The apparatus of claim 1, wherein the user interface unit comprises:
a first user interface to allow the user to store the plurality of first print settings in the storage unit; and
a second user interface to display the plurality of first print settings stored in the storage unit and to allow the user to select one or more of the displayed first print settings as the plurality of second print settings.

4. The apparatus of claim 3, wherein the second user interface comprises:
a display box to display the plurality of first print settings stored in the storage unit;
at least one input button to select the second print settings from the first print settings displayed on the display box, to remove one or more of the second print settings, or to add one or more new print settings to the second print settings; and
a displayer to display the selected plurality of second print settings.

5. The apparatus of claim 1, wherein the user interface unit and the controller are operated by a printer driver or a host application.

6. The apparatus of claim 5, further comprising:
a driver core to perform a plurality of print jobs under the control of the controller,
wherein the controller creates the plurality of print jobs according to the plurality of second print settings selected by the user and controls the driver core to perform the plurality of print jobs.

7. The apparatus of claim 5, further comprising:
a driver core to perform one print job under the control of the controller,
wherein the controller creates the one print job according to the plurality of second print settings selected by the user, transfers the plurality of second print settings to the driver core, and controls the driver core to repeatedly perform the one print job using the transferred plurality of second print settings.

8. A method of selecting a plurality of print settings, the method comprising:
displaying a plurality of first print settings and selecting a plurality of second print settings from the plurality of first print settings in a print setup operation.

9. The method of claim 8, wherein the first print settings are input via a user interface unit or are previously stored.

10. The method of claim 8, further comprising;
selecting one or more of the plurality of first print settings as the second print settings; and
(a2) storing the second print settings.

11. The method of claim 8, further comprising:
creating a print job according to the plurality of second print settings.

12. The method of claim 8, wherein the displaying of the plurality of first print settings comprises:
displaying the plurality of first print settings using a display box.

13. The method of claim 8, wherein the selecting of the plurality of second print settings comprises:
selecting at least one print setting from the first print settings displayed in the display box, or
modifying at least one print setting from the first print settings displayed in the display box and selecting the at least one modified first print setting.

14. The method of claim 13, where the modifying of the at least one first print setting comprises:
adding or removing one or more print options from the at least one first print setting using at least one input button.

15. The method of claim 8, further comprising:
displaying the selected plurality of second print settings.

16. The method of claim 11, further comprising:
performing the created print job.

17. The method of claim 11, wherein the creating of the print job according to the plurality of second print settings comprises:
creating a plurality of print jobs according to the plurality of second print settings; and
performing the created plurality of print jobs using a driver core.

18. The method of claim 11, wherein the creating of the print job according to the plurality of second print settings comprises:
creating one print job according to the plurality of second print settings;
transferring the plurality of second print settings to a driver core; and
controlling the driver core to repeatedly perform the one print job using the transferred plurality of second print settings.

19. A computer readable recording medium having embodied thereon a computer program to perform a method of selecting a plurality of print settings, the method comprising:
displaying a plurality of first print settings; and
selecting a plurality of second print settings from the plurality of first print settings in a print setup operation.

20. An apparatus to select a plurality of print settings, comprising:
an interface to display a plurality of first print settings, a button to select one or more of the first print settings as a plurality of second print settings, and the plurality of second print settings; and
a controller to print a document according to the plurality of second print settings.

21. The apparatus of claim 20, wherein the interface displays another button to delete at least one of the first print settings and the second print settings.

22. The apparatus of claim 20, wherein the interface displays another button to modify one or more print options of at least one of the plurality of second print settings.

23. A method of selecting a plurality of print settings, comprising:
displaying a plurality of first print settings, a button to select one or more of the first print settings as a plurality of second print settings, and the plurality of second print settings; and
printing a document according to the plurality of second print settings.

24. The method of claim 23, further comprising:
displaying another button to delete at least one of the first print settings and the second print settings.

25. The method of claim 23, further comprising:
displaying another button to modify one or more print options of at least one of the plurality of second print settings.

26. A method of printing using a plurality of desired print settings, comprising:
selecting one or more of a plurality of print settings as one or more second print settings in a print setup operation; and
printing using each of the second print settings separately.

27. An apparatus to print using a plurality of desired print settings, comprising:
a selection unit to select one or more of a plurality of stored print settings as one or more second print settings in a print setup operation; and
a control unit to control a printing operation using each of the plurality of second print settings separately.
